(19) United States
(12) Patent Application Publication
(10) Pub. No.: US 2023/0411054 A1
(43) Pub. Date: Dec. 21, 2023

(54) R-T-B MAGNET AND PREPARATION METHOD THEREFOR

(71) Applicant: Fujian Changting Golden Dragon Rare-Earth Co., Ltd, Fujian (CN)

(72) Inventors: Dakun Chen, Fujian (CN); Weiguo Mou, Fujian (CN); Jiaying Huang, Fujian (CN)

(21) Appl. No.: 18/458,290

(22) Filed: Aug. 30, 2023

Related U.S. Application Data
(63) Continuation of application No. PCT/CN22/72253, filed on Jan. 17, 2022.

(30) Foreign Application Priority Data
Mar. 17, 2021 (CN) 202110287760.5

(51) Int. Cl. H01F 1/057

(52) U.S. Cl. CPC H01F 1/0577

(57) ABSTRACT

The invention discloses an R-T-B magnet and a preparation method thereof. The R-T-B magnet comprises the following components of: ≥30.0 wt % of R, wherein R is a rare earth element; 0.1-0.3 wt % of Nb; 0.955-1.2 wt % of B; 58-69 wt % of Fe, wherein wt % is a percentage of the mass of respective component to the total mass of all components; the R-T-B magnet further comprises Co and Ti; and in the R-T-B magnet, the ratio of the mass content of Co to the total mass content of “the Nb and the Ti” is 4-10. The present invention further optimizes the coordination relationship among the components in the R-T-B magnet, which can prepare a magnet material with relatively high levels of magnetic properties such as remanence, coercivity, squareness and the like.

### CROSS-REFERENCE TO RELATED APPLICATIONS

This application is a continuation of International Patent Application No. PCT/CN2022/072253, which is a continuation of CN202110287760.5, both of which are incorporated in their entirety herein by reference and made a part hereof.

### TECHNICAL FIELD

The invention relates to an R-T-B magnet and a preparation method thereof.

### BACKGROUND OF THE INVENTION

As an important class of rare earth functional materials, neodymium-iron-boron permanent magnet materials have excellent comprehensive magnetic properties and are widely used in many fields such as the electronics industry and electric vehicles. However, the comprehensive magnetic properties of the current neodymium-iron-boron magnet materials are inferior, and it is difficult to prepare products with better performance, which cannot meet social needs.

For example, Chinese patent document CN106158204A discloses a neodymium-iron-boron permanent magnet material, which consists of the following components in percentage by weight: 15-30% of PrNd, 3-6% of Gd, 0.05-0.15% of Ga, 0.5-1.2% of B, 0.6-1.2% of Co, 0.3-0.8% of Al, 0.05-0.3% of Cu, 0.05-0.3% of Mo, 0.05-0.3% of Ti, and Fe as the balance. In this patent document, by adopting the above formula, a finer grain structure was obtained. The low-melting-point metal dissolved in the intergranular area firstly, which improved the solubility of the high-melting-point metal in the liquid phase, making it evenly distributed in the intergranular region. In addition, the high melting point metals can hinder the growth of grains and refine grains. However, the remanence and coercivity of the neodymium-iron-boron magnet with the above formula are still at a low level.

The technical problem that needs to be solved at present is to find a formula for neodymium iron boron magnets, and the magnet materials prepared by it have relatively high levels of magnetic properties such as remanence, coercivity, squareness and the like, which can be used in areas with high demands.

### SUMMARY OF THE INVENTION

In order to solve the defect that the R-T-B magnet formula in the prior art has a low synergistic effect, and the remanence, coercivity and squareness of the obtained magnet material cannot reach a higher level at the same time, the invention provides an R-T-B magnet and its preparation method. Through the specific cooperation among the components in the R-T-B magnet of the present invention, the magnet materials with relatively high levels of magnetic properties such as remanence, coercivity and squareness can be prepared.

The present invention solves the above-mentioned technical problem mainly through the following technical solutions.

The invention provides a R-T-B magnet, comprising the following components of:
≥30.0 wt % of R, wherein R is a rare earth element;
0.1-0.3 wt % of Nb;
0.955-1.2 wt % of B;
58-69 wt % of Fe, wherein
wt % is a percentage of the mass of respective component to the total mass of all components;
the R-T-B magnet further comprises Co and Ti; and in the R-T-B magnet, the ratio of the mass content of Co to the total mass content of “the Nb and the Ti” is 4-10.

In the invention, according to the R-T-B magnet, it is known that the above total mass of all components comprises the mass content of Co and Ti.

In the invention, the content of R is preferably 30-32 wt %, such as 30.5 wt %, 30.6 wt % or 30.7 wt %.

In the invention, the R generally further comprises Nd.

Wherein, the content of Nd can be conventional in this field. The content of Nd is preferably 22-32 wt %, such as 28.2 wt %, 28.4 wt %, 29.2 wt %, 29.3 wt %, 29.4 wt %, 29.5 wt %, 29.8 wt %, 29.9 wt % or 30.3 wt %, wherein wt % is the mass percentage of Nd in the total mass of all components.

In the invention, the R generally further comprises Pr and/or RH, wherein the RH is a heavy rare earth element.

Wherein, the content of the Pr is preferably 0.3 wt % or less, such as 0.2 wt %, wherein wt % is the mass percentage of Pr in the total mass of all components.

Wherein, the content of the RH is preferably 3 wt % or less, such as 0.2 wt %, 0.6 wt %, 0.8 wt %, 1.1 wt %, 1.2 wt %, 1.4 wt %, 2.3 wt % or 2.5 wt %, wherein wt % is the mass percentage of RH in the total mass of all components.

Wherein, the RH preferably comprises Tb or Dy.

When the RH comprises Tb, the content of Tb is preferably 0.2-1.1 wt %, such as 0.2 wt %, 0.5 wt %, 0.6 wt %, 0.8 wt % or 1.1 wt %, wherein wt % is the mass percentage of Tb in the total mass of all components.

When the RH comprises Dy, the content of Dy is preferably 0.5-2.5 wt %, such as 0.6 wt %, 1.2 wt %, 1.8 wt % or 2.5 wt %, wherein wt % is the mass percentage of Dy in the total mass of all components.

Wherein, a ratio of the atomic percentage of RH to the atomic percentage of R can be 0.1 or less, such as 0.02, 0.04, 0.06 or 0.08, wherein the atomic percentage is the atomic percentage in the total content of all components.

In the invention, the content of Nb is preferably 0.15-0.25 wt %, such as 0.16 wt %, wt %, 0.2 wt %, 0.22 wt %, 0.23 wt % or 0.24 wt %.

In the invention, in the R-T-B magnet, the ratio of the mass content of Co to the total mass content of “the Nb and the Ti” is preferably 4.6-8.4, such as 4.6, 5.3, 5.5, 6.5, 6.6, 6.7, 6.8, 7.9 or 8.4, more preferably 4-7.

In the invention, the content of Co is preferably 1.5-3.5 wt %, such as 2 wt %, 2.5 wt %, 2.6 wt %, 2.8 wt % or 3 wt %.

In the invention, the content of Ti is 0.15-0.35 wt %, such as 0.15 wt %, 0.18 wt %, 0.23 wt %, 0.25 wt % or 0.35 wt %.

In the invention, the content of B is preferably 0.955-1.1 wt %, such as 0.99 wt %.

In the invention, the ratio of the atomic percentage of B to the atomic percentage of R in the R-T-B magnet is 0.38 or more, such as 0.41, 0.42, 0.43 or 0.44, wherein the atomic percentage is the atomic percentage in the total content of all components.

In the invention, the content of the Fe preferably is 65-66 wt %, such as 64.67 wt %, 64.71 wt %, 64.88 wt %, 64.89 wt %, 64.98 wt %, 65.07 wt %, 65.13 wt %, 65.14 wt %, 65.33 wt %, 65.38 wt % or 65.64 wt %.

In the invention, the R-T-B magnet can further comprise Cu.

Wherein, the content of Cu can be 0.1-0.4 wt %, such as 0.1 wt %, 0.15 wt %, 0.25 wt %, 0.3 wt %, 0.36 wt % or 0.39 wt %, wherein wt % is the mass percentage of Cu in the total mass of all components.

In the present invention, those skilled in the art know that unavoidable impurities, such as one or more of C, O and Mn, are generally introduced during the preparation of the R-T-B magnet.

The inventors found that through the magnet component formula of the specific coordination relationship between the above elements and their contents, after the R-T-B magnet is prepared, the magnetic properties of the obtained magnet material such as coercivity, remanence and squareness are all at higher level. After further analysis, it was found that compared to the magnet material without this formulation, the R-T-B magnet with this formulation has a Co—Ti—Nb phase formed in the intergranular triangular region. The presence of the Co—Ti—Nb phase significantly hinders grain growth.

In the invention, the R-T-B magnet preferably further comprises a Co—Ti—Nb phase; the Co—Ti—Nb phase is located in an intergranular triangular region, and a ratio of the area of the Co—Ti—Nb phase in the intergranular triangular region to the total area of the intergranular triangular region is 1.1-2.5%. In the present invention, the intercrystalline triangular region can have the meaning of conventional understanding in the art, which generally refers to the grain boundary phase formed among three or more main phase particles. The area of the Co—Ti—Nb phase and the total area of the intergranular triangular region generally refer to the areas respectively occupied in the cross section of the R-T-B magnet when detected by FE-EPMA.

Wherein, in the Co—Ti—Nb phase, the atomic percent ratio of Co, Ti and Nb is close to 8:1:1. The Co—Ti—Nb phase is preferably a Co₈Ti₁Nb₁ phase.

Wherein, the ratio of the area of the Co—Ti—Nb phase in the intergranular triangular region to the total area of the intergranular triangular region is, for example, 1.1%, 1.2%, 1.3%, 1.4%, 1.5%, 1.6%, 1.7%, 1.8%, 1.9% or 2%.

In a preferable example of the invention, the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%.

In a preferable example of the invention, the R-T-B magnet comprises the following components of: 29.5 wt % of Nd, 1.1 wt % of Tb, 0.36 wt % of Cu, 2.6 wt % of Co, 0.23 wt % of Ti, 0.24 wt % of Nb, 0.99 wt % of B and 64.98 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%.

In a preferable example of the invention, the R-T-B magnet comprises the following components of: 29.5 wt % of Nd, 1.1 wt % of Tb, 0.36 wt % of Cu, 2.6 wt % of Co, 0.35 wt % of Ti, 0.22 wt % of Nb, 0.99 wt % of B and 64.88 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%.

In a preferable example of the invention, the R-T-B magnet comprises the following components of: 29.5 wt % of Nd, 1.1 wt % of Tb, 0.36 wt % of Cu, 2.6 wt % of Co, 0.15 wt % of Ti, 0.16 wt % of Nb, 0.99 wt % of B and 65.14 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.5%.

In a preferable example of the invention, the R-T-B magnet comprises the following components of: 29.5 wt % of Nd, 1.1 wt % of Tb, 0.36 wt % of Cu, 3 wt % of Co, 0.18 wt % of Ti, 0.2 wt % of Nb, 0.99 wt % of B and 64.67 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%.

In a preferable example of the invention, the R-T-B magnet comprises the following components of: 29.8 wt % of Nd, 0.8 wt % of Tb, 0.3 wt % of Cu, 2.6 wt % of Co, 0.18 wt % of Ti, 0.2 wt % of Nb, 0.99 wt % of B and 65.13 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.9%.

In a preferable example of the invention, the R-T-B magnet comprises the following components of: 29.9 wt % of Nd, 0.6 wt % of Tb, 0.25 wt % of Cu, 2.5 wt % of Co, 0.18 wt % of Ti, 0.2 wt % of Nb, 0.99 wt % of B and 65.38 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%.

In a preferable example of the invention, the R-T-B magnet comprises the following components of: 30.3 wt % of Nd, 0.2 wt % of Tb, 0.39 wt % of Cu, 2.8 wt % of Co, 0.23 wt % of Ti, 0.2 wt % of Nb, 0.99 wt % of B and 64.89 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%.

In a preferable example of the invention, the R-T-B magnet comprises the following components of: 28.2 wt % of Nd, 2.5 wt % of Dy, 0.15 wt % of Cu, 3 wt % of Co, 0.25 wt % of Ti, 0.2 wt % of Nb, 0.99 wt % of B and 64.71 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%.

In a preferable example of the invention, the R-T-B magnet comprises the following components of: 28.4 wt % of Nd, 0.5 wt % of Tb, 1.8 wt % of Dy, 0.1 wt % of Cu, 2.5 wt % of Co, 0.18 wt % of Ti, 0.2 wt % of Nb, 0.99 wt % of B and 65.33 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%.

In a preferable example of the invention, the R-T-B magnet comprises the following components of: 29.4 wt % of Nd, 1.2 wt % of Dy, 0.39 wt % of Cu, 2 wt % of Co, 0.18 wt % of Ti, 0.2 wt % of Nb, 0.99 wt % of B and 65.64 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%.

In a preferable example of the invention, the R-T-B magnet comprises the following components of: 29.2 wt % of Nd, 0.8 wt % of Tb, 0.6 wt % of Dy, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.6%.

In a preferable example of the invention, the R-T-B magnet comprises the following components of: 29.3 wt % of Nd, 0.2 wt % of Pr, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%.

In a preferable example of the invention, the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.2%.

In a preferable example of the invention, the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.1%.

The invention provides a preparation method of a R-T-B magnet, comprising the steps of subjecting a raw mixture comprising the respective components for the R-T-B magnet as mentioned above to a smelting treatment, an air cooling treatment and an aging treatment in turn.

In the present invention, the process for the sintering treatment may be conventional in the field.

Wherein, the temperature for the sintering treatment is preferably 1000-1100° C., such as 1080° C.

Wherein, the sintering is preferably performed under a vacuum condition, such as a vacuum condition of 5×10⁻³ Pa.

Wherein, the time for the sintering treatment can be conventional in the field, and can be 4-8 hours, for example, 6 hours.

In the present invention, the temperature for the air cooling treatment is preferably 550-950° C., such as 550° C., 600° C., 650° C., 700° C., 750° C., 800° C. or 950° C.

In the present invention, those skilled in the art know that the temperature for the air cooling treatment generally refers to the temperature at which a fan is turned on to rapidly cool the material to room temperature when the material is naturally cooled to the temperature of the air cooling treatment after the sintering treatment. There is no particular limitation on the time for the air cooling treatment described in the present invention, which can be adjusted appropriately according to the different temperatures of the air cooling treatment.

In the present invention, the aging treatment can adopt the conventional aging process in the field, which generally includes a primary aging and a secondary aging.

Wherein, the temperature for the primary aging treatment may be 860-920° C., such as 880° C. or 900° C.

Wherein, the time for the primary aging treatment may be 2.5-4 hours, such as 3 hours.

Wherein, the temperature for the secondary aging treatment may be 460-530° C., such as 500° C., 510° C. or 520° C.

Wherein, the time for the secondary aging treatment may be 2.5-4 hours, such as 3 hours.

In the present invention, when the R-T-B magnet comprises heavy rare earth elements, the preparation method generally can comprise grain boundary diffusion after the aging treatment.

Wherein, the grain boundary diffusion can be a conventional process in the field, and generally the heavy rare earth elements are diffused by the grain boundary diffusion.

The temperature for the grain boundary diffusion may be 800-900° C., such as 850° C. The time for the grain boundary diffusion may be 5-10 hours, such as 8 hours.

Wherein, the method of adding heavy rare earth elements in the R-T-B magnet can refer to conventional methods in this field. Generally, 0-80% of heavy rare earth elements are added during smelting and the rest are added during grain boundary diffusion, such as 25%, 30%, 40%, 50% or 67%. The heavy rare earth elements added during smelting are, for example, Tb.

For example, when the heavy rare earth elements in the R-T-B magnet are Tb with a content of greater than 0.5 wt %, 25-67% of Tb is added during the smelting, and the rest is added during the grain boundary diffusion. For example, when the heavy rare earth elements in the R-T-B magnet are Tb and Dy, the Tb is added during smelting, and the Dy is added during the grain boundary diffusion. For example, when the heavy rare earth elements in the R-T-B magnet are Tb with a content of less than or equal to 0.5 wt %, or when the heavy rare earth elements in the R-T-B magnet are Dy, the heavy rare earth elements in the R-T-B magnet are added during the grain boundary diffusion.

The temperature for the grain boundary diffusion may be 800-900° C., such as 850° C. The time for the grain boundary diffusion may be 5-10 hours, such as 8 hours.

In the invention, the preparation method generally further comprises the steps of subjecting the raw material mixture comprising respective components of the R-T-B magnet to smelting, casting, hydrogen decrepitation, pulverization and magnetic field shaping before the sintering treatment.

Wherein, the smelting can adopt a conventional smelting process in the art.

The vacuum degree for the smelting is, for example, 5×10⁻² Pa.

The temperature for the smelting is, for example, 1550° C. or less.

The smelting is generally carried out in a high-frequency vacuum induction melting furnace.

Wherein, the casting process can adopt conventional techniques in the field.

The casting process, for example can be a strip casting process.

The temperature for the casting may be 1390-1460° C., preferably 1410-1440° C., for example 1430° C.

The alloy sheet obtained after the casting can have a thickness of 0.25-0.40 mm, such as 0.29 mm.

Wherein, the process of the hydrogen decrepitation generally comprises hydrogen absorption, dehydrogenation, and a cooling treatment in turn.

The hydrogen absorption can be carried out under a condition of a hydrogen pressure of 0.085 MPa.

The dehydrogenation can be carried out under the condition of raising the temperature while evacuating, and the temperature for the dehydrogenation can be 480-520° C., For example, 500° C.

Wherein, the pulverization process can adopt the conventional technology in the field, such as jet mill pulverization.

The pulverization can be carried out in a gas atmosphere with an oxidizing gas content of 1000 ppm or less, and the oxidizing gas content refers to the content of oxygen or moisture.

The pressure during the pulverization is, for example, 0.68 MPa.

After the pulverization, a lubricant such as zinc stearate is generally added.

The added amount of the lubricant may be 0.05-0.15%, for example 0.12%, of the mass of the powder obtained after the pulverization.

Wherein, the process for the magnetic field shaping may adopt a conventional process in the art.

The magnetic field shaping can be carried out at magnetic field strength of 1.8 T or more under the protection of nitrogen atmosphere. For example, it is carried out at a magnetic field strength of 1.8-2.5 T.

The invention further provides a R-T-B magnet prepared by the preparation method as mentioned above.

On the basis of conforming to common knowledge in the field, the above-mentioned preferred conditions can be combined arbitrarily to obtain the preferred examples of the present invention.

The reagents and raw materials used in the present invention are all commercially available.

The positive progress effects of the present invention are as follows:

In the present invention, the formulation of the R-T-B magnet is further optimized through Co, Ti and Nb with a specific coordination relationship as well as B and other elements, the coercivity of the obtained R-T-B magnet is significantly improved, and the remanence, high stability, squareness and other magnetic properties of the obtained R-T-B magnet are at a higher level.

### BRIEF DESCRIPTION OF THE DRAWINGS

FIG. 1 shows the SEM image of the R-T-B magnet in Example 1. The arrow A in FIG. 1 indicates the Co—Ti—Nb phase in the intergranular triangular region by the single-point quantitative analysis.

### DETAILED DESCRIPTION OF THE INVENTION

The present invention is further illustrated below by means of examples, but the present invention is not limited to the scope of the examples. The experimental methods not indicating specific conditions in the following examples were carried out according to the conventional methods and conditions, or were selected according to the product instructions.

### Example 1

Raw materials were prepared according to the compositions of the R-T-B magnet of Example 1 shown in Table 1 below to obtain a raw material mixture. The raw material mixture (0.4 wt % of Tb in the formula in Table 1 was added during the smelting) was sequentially subjected to smelting, casting, hydrogen decrepitation, pulverization, magnetic field shaping, sintering treatment, air cooling treatment, aging treatment and grain boundary diffusion.

The preparation process of the R-T-B magnet is as follows:

(1) Smelting:

The raw material mixture was smelted in a high-frequency vacuum induction melting furnace with a vacuum degree of 5×10⁻² Pa at a smelting temperature of 1550° C. or less.

(2) Casting:

An alloy cast sheet having a thickness of 0.29 mm was obtained by the strip casting process, wherein the casting temperature was 1430° C.

(3) Hydrogen Decrepitation:

The material was subjected to hydrogen absorption, dehydrogenation and cooling treatments. The hydrogen absorption was carried out under the condition of hydrogen pressure of 0.085 MPa, the dehydrogenation was carried out under the condition of raising the temperature while evacuating, and the dehydrogenation temperature is 500° C.

(4) Pulverization Process:

Jet mill pulverization was performed in an atmosphere having an oxidizing gas content of 100 ppm or less. The oxidizing gas referred to oxygen or moisture content. The pressure in the grinding chamber of the jet mill was 0.68 MPa. After pulverization, a lubricant, that is, zinc stearate, was added, wherein the addition of the lubricant was 0.12% of the powder weight after mixing.

(6) Magnetic Field Shaping:

It was carried out at a magnetic field strength of 1.8-2.5 T under the protection a nitrogen atmosphere.

(7) Sintering Treatment:

The sintering treatment was performed at 1080° C. for 6 h under a vacuum condition of 5×10⁻³ Pa. Before cooling, Ar gas can be introduced to make the pressure reach 0.05 MPa.

(8) Air Cooling Treatment:

After the sintering treatment, it was naturally cooled to 650° C., and the fan was turned on to quickly cool to room temperature.

(9) Aging Treatment:

The primary aging was carried out at a temperature of 900° C. for 3 hours; the secondary aging was carried out at a temperature of 510° C. for 3 hours.

(9) Grain Boundary Diffusion:

The remaining heavy rare earth elements (0.7 wt % Tb) were melted and attached on the surface of the material, and grain boundary diffusion was carried out at 850° C. for 8 h.

2. The raw materials and the air cooling temperatures regarding the R-T-B magnets in Examples 2-15 and Comparative Examples 1-4 are shown in Table 1 below, and the rest of the preparation process was the same as that in Example 1. In Examples 2-7, 13-15 and Comparative Examples 1-4, 0.4 wt % of Tb was added during smelting, and the remaining Tb was diffused into the R-T-B magnets through grain boundary diffusion. In Examples 8, 9 and 11, the heavy rare earth elements were all added into the R-T-B magnet through grain boundary diffusion. In Examples 10 and 12, Tb was added during smelting, while Dy was diffused into the R-T-B magnet through grain boundary diffusion.

### Effect Example 1

1. Determination of Components:

The R-T-B magnets in Examples 1-15 and Comparative Examples 1-4 were measured using a high-frequency inductively coupled plasma optical emission spectrometer (ICP-OES). The test results are shown in Table 1 below.

TABLE 1
Components and contents (wt %) of the R-T-B magnets

| | | | | | | | | | | | | Co/ | Temperature for |
|---|---|---|---|---|---|---|---|---|---|---|---|---|---|
| | | | | | | | | | | | Ti + | (Nb + | Air Cooling |
| | Nd | Pr | Tb | Dy | Cu | Co | Ti | Nb | B | Fe | Nb | Ti) | Treatment ° C. |
| Example 1 | 29.5 | / | 1.1 | / | 0.36 | 2.6 | 0.18 | 0.2 | 0.99 | 65.07 | 0.38 | 6.8 | 650 |
| Example 2 | 29.5 | / | 1.1 | / | 0.36 | 2.6 | 0.23 | 0.24 | 0.99 | 64.98 | 0.47 | 5.5 | 650 |
| Example 3 | 29.5 | / | 1.1 | / | 0.36 | 2.6 | 0.35 | 0.22 | 0.99 | 64.88 | 0.57 | 4.6 | 700 |
| Example 4 | 29.5 | / | 1.1 | / | 0.36 | 2.6 | 0.15 | 0.16 | 0.99 | 65.14 | 0.31 | 8.4 | 750 |
| Example 5 | 29.5 | / | 1.1 | / | 0.36 | 3 | 0.18 | 0.2 | 0.99 | 64.67 | 0.38 | 7.9 | 700 |
| Example 6 | 29.8 | / | 0.8 | / | 0.3 | 2.6 | 0.18 | 0.2 | 0.99 | 65.13 | 0.38 | 6.8 | 700 |
| Example 7 | 29.9 | / | 0.6 | / | 0.25 | 2.5 | 0.18 | 0.2 | 0.99 | 65.38 | 0.38 | 6.6 | 650 |
| Example 8 | 30.3 | / | 0.2 | / | 0.39 | 2.8 | 0.23 | 0.2 | 0.99 | 64.89 | 0.43 | 6.5 | 650 |
| Example 9 | 28.2 | / | / | 2.5 | 0.15 | 3 | 0.25 | 0.2 | 0.99 | 64.71 | 0.45 | 6.7 | 650 |
| Example 10 | 28.4 | / | 0.5 | 1.8 | 0.1 | 2.5 | 0.18 | 0.2 | 0.99 | 65.33 | 0.38 | 6.6 | 800 |
| Example 11 | 29.4 | / | / | 1.2 | 0.39 | 2 | 0.18 | 0.2 | 0.99 | 65.64 | 0.38 | 5.3 | 750 |
| Example 12 | 29.2 | / | 0.8 | 0.6 | 0.36 | 2.6 | 0.18 | 0.2 | 0.99 | 65.07 | 0.38 | 6.8 | 750 |
| Example 13 | 29.3 | 0.2 | 1.1 | / | 0.36 | 2.6 | 0.18 | 0.2 | 0.99 | 65.07 | 0.38 | 6.8 | 600 |
| Example 14 | 29.5 | / | 1.1 | / | 0.36 | 2.6 | 0.18 | 0.2 | 0.99 | 65.07 | 0.38 | 6.8 | 550 |
| Example 15 | 29.5 | / | 1.1 | / | 0.36 | 2.6 | 0.18 | 0.2 | 0.99 | 65.07 | 0.38 | 6.8 | 950 |
| Comparative | 29.5 | / | 1.1 | / | 0.36 | 2.6 | 0.56 | 0.3 | 0.99 | 64.59 | 0.86 | 3.0 | 650 |
| Example 1 | | | | | | | | | | | | | |
| Comparative | 29.5 | / | 1.1 | / | 0.39 | 2.6 | 0.13 | 0.1 | 0.99 | 65.19 | 0.23 | 11.3 | 650 |
| Example 2 | | | | | | | | | | | | | |
| Comparative | 29.5 | / | 1.1 | / | 0.39 | 2.6 | 0.18 | 0.05 | 0.99 | 65.19 | 0.23 | 11.3 | 650 |
| Example 3 | | | | | | | | | | | | | |
| Comparative | 29.5 | / | 1.1 | / | 0.39 | 2.6 | 0.18 | 0.4 | 0.99 | 64.84 | 0.58 | 4.5 | 650 |
| Example 4 | | | | | | | | | | | | | |

Note:
/ indicates that the element is not added. Ga and Zr were not detected in the R-T-B magnets of the above-mentioned examples and comparative examples. C, O and Mn were inevitably introduced into the R-T-B magnet as the final product during the preparation process. The content percentages recorded in the various examples and comparative examples do not include these impurities.

2. Testing for Magnetic Performance

At room temperature 20° C., the R-T-B magnets in Examples 1-15 and Comparative Examples 1-4 were tested by using a PFM pulsed BH demagnetization curve testing equipment to obtain the data of remanence (Br), intrinsic coercivity (Hcj), maximum energy product (BHmax) and squareness (Hk/Hcj). The testing results are shown in Table 2 below.

TABLE 2

| | | | | Hk/ |
|---|---|---|---|---|
| | Br(kGs) | Hcj(kOe) | BHmax(MGOe) | Hcj |
| Example 1 | 14.4 | 26.5 | 49.30 | 0.99 |
| Example 2 | 14.3 | 26.8 | 48.89 | 0.99 |
| Example 3 | 14.3 | 26.9 | 48.69 | 0.98 |
| Example 4 | 14.4 | 26.4 | 49.23 | 0.99 |
| Example 5 | 14.4 | 26.9 | 49.30 | 0.98 |
| Example 6 | 14.4 | 25.3 | 49.58 | 0.99 |
| Example 7 | 14.5 | 24.4 | 49.99 | 0.99 |
| Example 8 | 14.7 | 23.5 | 51.24 | 0.99 |
| Example 9 | 13.9 | 24.4 | 46.00 | 0.99 |
| Example 10 | 14.0 | 28.7 | 46.67 | 0.99 |
| Example 11 | 14.3 | 21.7 | 48.55 | 0.99 |
| Example 12 | 14.3 | 26.8 | 48.35 | 0.99 |
| Example 13 | 14.4 | 26.6 | 49.37 | 0.99 |
| Example 14 | 14.4 | 25.4 | 49.30 | 0.95 |
| Example 15 | 14.4 | 25.5 | 49.30 | 0.94 |
| Comparative Example 1 | 14.4 | 24.4 | 49.30 | 0.98 |
| Comparative Example 2 | 14.4 | 24.6 | 49.30 | 0.99 |
| Comparative Example 3 | 14.4 | 24.5 | 49.30 | 0.97 |
| Comparative Example 4 | 14.4 | 24.3 | 49.30 | 0.99 |

3. Testing for Microstructures FE-EPMA Detection:

The vertically oriented faces of the R-T-B magnets in Examples 1-15 and Comparative Examples 1-4 were polished, and tested by using a Field Emission Electron Probe Microanalyzer (FE-EPMA) (JEOL, 8530F). Firstly, the distribution of Co, Ti and Nb elements in the R-T-B magnets was determined by surface scanning using FE-EPMA. Then, the contents of respective elements in the Co—Ti—Nb phase were determined by single-point quantitative analysis using FE-EPMA. The test conditions included an accelerating voltage of 15 kv and a probe beam current of 50 nA. It was detected that the ratio of Co, Ti and Nb elements in the Co—Ti—Nb phases in Examples 1-15 was close to 8:1:8. The testing results are shown in Table 3 below.

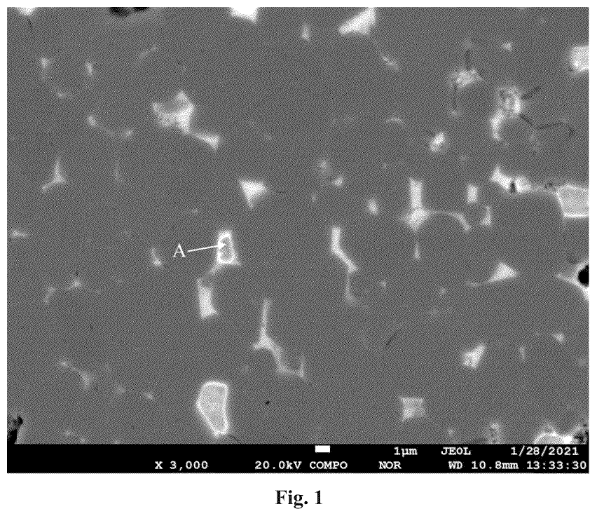

FIG. 1 shows the SEM image for the microstructure of the R-T-B magnet in Example 1 detected by FE-EPMA. The position indicated by the arrow A in FIG. 1 refers to the Co—Ti—Nb phase in the intergranular triangular region by the single-point quantitative analysis. Through detection and calculation, it is clear that a Co₈Ti₁Nb₁ phase was formed in the intergranular triangular region in the R-T-B magnet of the present invention, and the ratio of the area of the phase in the intergranular triangular region to the total area of the intergranular triangular region (hereinafter referred to as Area Percentage of Co₈Ti₁Nb₁ Phase) was 2%. The area of the Co₈Ti₁Nb₁ phase and the area of the intergranular triangular region respectively refer to the areas thereof occupied in the cross-section (that is, the vertically oriented face as mentioned above) of the detected R-T-B magnet. The testing results of Examples 2-15 and Comparative Examples 1-4 are shown in Table 3 below.

TABLE 3

| | Whether Co₈Ti₁Nb₁ | Area Percentage of |
|---|---|---|
| | phase is formed | Co₈Ti₁Nb₁ Phase (%) |
| Example 1 | Yes | 2.0 |
| Example 2 | Yes | 1.8 |
| Example 3 | Yes | 1.7 |
| Example 4 | Yes | 1.9 |
| Example 5 | Yes | 2.0 |
| Example 6 | Yes | 1.9 |
| Example 7 | Yes | 2.0 |
| Example 8 | Yes | 1.8 |
| Example 9 | Yes | 1.8 |
| Example 10 | Yes | 1.8 |
| Example 11 | Yes | 1.7 |
| Example 12 | Yes | 1.8 |
| Example 13 | Yes | 1.8 |
| Example 14 | Yes | 1.2 |
| Example 15 | Yes | 1.1 |
| Comparative Example 1 | No | / |
| Comparative Example 2 | No | / |
| Comparative Example 3 | Yes | 0.7 |
| Comparative Example 4 | Yes | 1.0 |

From the above experimental data, it can be seen that the remanence, coercivity, high temperature stability, magnetic energy product and squareness of the magnet materials prepared according to the formula for R-T-B magnet designed by the inventors are all at a relatively high level, and its comprehensive magnetic properties are excellent, which are suitable for applications in areas with high demands. After further analysis of the microstructure, the inventors found that after the R-T-B magnets with the above specific formula as magnet materials were prepared, a specific area percentage of a Co₈Ti₁Nb₁ phase was formed in the intergranular triangular region of the magnets. The existence of this phase significantly hinders the grain growth, thereby improving the coercivity and other magnetic properties of the R-T-B magnets. If the formulation of the R-T-B magnet does not fall within the scope of the present invention, the Co₈Ti₁Nb₁ phase cannot be obtained or only a small amount of this phase can be obtained, and thus it is difficult to significantly improve the magnetic performance of the R-T-B magnets.

1. A R-T-B magnet, comprising the following components of:
≥30.0 wt % of R, 0.1-0.3 wt % of Nb, 0.955-1.2 wt % of B, 58-69 wt % of Fe, Co, and Ti;
wherein R is a rare earth element and wt % is a percentage of the mass of respective component to the total mass of all components; and
the ratio of the mass content of Co to the total mass content of the Nb and the Ti is 4-10.

2. The R-T-B magnet according to claim 1, wherein:
the content of R is 30-32 wt %; and/or
the R further comprises Nd;
wherein, the content of Nd is 22-32 wt %; and/or
the R further comprises Pr and/or RH, wherein the RH is a heavy rare earth element;
wherein, the content of the Pr is 0.3 wt % or less;
wherein, the content of the RH is 3 wt % or less;
wherein, the RH comprises Tb or Dy;
when the RH comprises Tb, the content of Tb is 0.2-1.1 wt %;
when the RH comprises Dy, the content of Dy is 0.5-2.5 wt %;
wherein a ratio of the atomic percentage of RH to the atomic percentage of R is 0.1 or less.

3. The R-T-B magnet according to claim 1, wherein:
the content of Nb is 0.15-0.25 wt %; and/or
the ratio of the mass content of Co to the total mass content of “the Nb and the Ti” is 4.6-8.4; and/or
the content of Co is 1.5-3.5 wt %; and/or
the content of Ti is 0.15-0.35 wt %.

4. The R-T-B magnet according to claim 1, wherein:
the content of B is 0.955-1.1 wt %; and/or
the ratio of the atomic percentage of B to the atomic percentage of R in the R-T-B magnet is 0.38 or more; and/or
the content of the Fe is 65-66 wt %; and/or
the R-T-B magnet further comprises Cu;
wherein, the content of Cu is 0.1-0.4 wt %.

5. The R-T-B magnet according to claim 1, wherein the R-T-B magnet further comprises:
a Co—Ti—Nb phase located in an intergranular triangular region, and a ratio of the area of the Co—Ti—Nb phase in the intergranular triangular region to the total area of the intergranular triangular region is 1.1-2.5%; and
wherein the Co—Ti—Nb phase is a Co₈Ti₁Nb₁ phase.

6. The R-T-B magnet according to claim 1, wherein:
the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%; or
the R-T-B magnet comprises the following components of: 29.5 wt % of Nd, 1.1 wt % of Tb, 0.36 wt % of Cu, 2.6 wt % of Co, 0.23 wt % of Ti, 0.24 wt % of Nb, 0.99 wt % of B and 64.98 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%; or
the R-T-B magnet comprises the following components of: 29.5 wt % of Nd, 1.1 wt % of Tb, 0.36 wt % of Cu, 2.6 wt % of Co, 0.35 wt % of Ti, 0.22 wt % of Nb, 0.99 wt % of B and 64.88 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%; or
the R-T-B magnet comprises the following components of: 29.5 wt % of Nd, 1.1 wt % of Tb, 0.36 wt % of Cu, 2.6 wt % of Co, 0.15 wt % of Ti, 0.16 wt % of Nb, 0.99 wt % of B and 65.14 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.5%; or
the R-T-B magnet comprises the following components of: 29.5 wt % of Nd, 1.1 wt % of Tb, 0.36 wt % of Cu, 3 wt % of Co, 0.18 wt % of Ti, 0.2 wt % of Nb, 0.99 wt % of B and 64.67 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%; or
the R-T-B magnet comprises the following components of: 29.8 wt % of Nd, 0.8 wt % of Tb, 0.3 wt % of Cu, 2.6 wt % of Co, 0.18 wt % of Ti, 0.2 wt % of Nb, 0.99 wt % of B and 65.13 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.9%; or
the R-T-B magnet comprises the following components of: 29.9 wt % of Nd, 0.6 wt % of Tb, 0.25 wt % of Cu, 2.5 wt % of Co, 0.18 wt % of Ti, 0.2 wt % of Nb, 0.99 wt % of B and 65.38 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 2%; or
the R-T-B magnet comprises the following components of: 30.3 wt % of Nd, 0.2 wt % of Tb, 0.39 wt % of Cu, 2.8 wt % of Co, 0.23 wt % of Ti, 0.2 wt % of Nb, 0.99 wt % of B and 64.89 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%; or
the R-T-B magnet comprises the following components of: 28.2 wt % of Nd, 2.5 wt % of Dy, 0.15 wt % of Cu, 3 wt % of Co, 0.25 wt % of Ti, 0.2 wt % of Nb, 0.99 wt % of B and 64.71 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%; or
the R-T-B magnet comprises the following components of: 28.4 wt % of Nd, 0.5 wt % of Tb, 1.8 wt % of Dy, 0.1 wt % of Cu, 2.5 wt % of Co, 0.18 wt % of Ti, 0.2 wt % of Nb, 0.99 wt % of B and 65.33 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.8%; or
the R-T-B magnet comprises the following components of: 29.4 wt % of Nd, 1.2 wt % of Dy, 0.39 wt % of Cu, 2 wt % of Co, 0.18 wt % of Ti, 0.2 wt % of Nb, 0.99 wt % of B and 65.64 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%; or
the R-T-B magnet comprises the following components of: 29.2 wt % of Nd, 0.8 wt % of Tb, 0.6 wt % of Dy, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.6%; or
the R-T-B magnet comprises the following components of: 29.3 wt % of Nd, 0.2 wt % of Pr, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.7%; or
the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.2%; or
the R-T-B magnet comprises the following components of: 29.5 wt % of Nd, 1.1 wt % of Tb, 0.36 wt % of Cu, 2.6 wt % of Co, 0.18 wt % of Ti, 0.2 wt % of Nb, 0.99 wt % of B and 65.07 wt % of Fe, wherein wt % is the ratio of the mass of respective component to the total mass of all components; the R-T-B magnet comprises a Co₈Ti₁Nb₁ phase in an intergranular triangular region thereof; and the ratio of the area of the Co₈Ti₁Nb₁ phase to the total area of the intergranular triangular region is 1.1%.

7. A preparation method of a R-T-B magnet, comprising the steps of subjecting a raw mixture comprising the respective components for the R-T-B magnet according to claim 1 to a smelting treatment, an air cooling treatment and an aging treatment in turn.

8. The preparation method of the R-T-B magnet according to claim 7, wherein:
the temperature for the sintering treatment is 1000-1100° C.; and/or
the time for the sintering treatment is 4-8 h; and/or
the temperature for the air cooling treatment is 550-950° C.; and/or
the aging treatment comprises a primary aging treatment and a secondary aging treatment;
wherein the temperature for the primary aging treatment is 860-920° C.;
wherein the time for the primary aging treatment is 2.5-4 h;
wherein the temperature for the secondary aging treatment is 460-530° C.;
wherein the time for the secondary aging treatment is 2.5-4 h; and/or
wherein, when the R-T-B magnet comprises a heavy rare earth element, the preparation method further comprises a grain boundary diffusion after the aging treatment;
wherein, the temperature for the grain boundary diffusion is 800-900° C.;
wherein, the time for the grain boundary diffusion is 5-10 h;
wherein, the method of adding heavy rare earth elements in the R-T-B magnet comprises the steps of adding 0-80% of heavy rare earth elements during the smelting and adding the remaining heavy rare earth elements during the grain boundary diffusion; when the heavy rare earth elements in the R-T-B magnet are Tb with a content of greater than 0.5 wt %, 25-67% of Tb is added during the smelting, and the rest is added during the grain boundary diffusion; or, when the heavy rare earth elements in the R-T-B magnet are Tb and Dy, the Tb is added during smelting, and the Dy is added during the grain boundary diffusion; or when the heavy rare earth elements in the R-T-B magnet are Tb with a content of less than or equal to 0.5 wt %, or when the heavy rare earth elements in the R-T-B magnet are Dy, the heavy rare earth elements in the R-T-B magnet are added during the grain boundary diffusion.

9. The preparation method of the R-T-B magnet according to claim 7, wherein the preparation method further comprises the steps of smelting, casting, hydrogen decrepitation, pulverization and shaping treatment before the sintering treatment,
wherein, the temperature for the smelting is 1550° C. or less;
wherein, the temperature for the casting is 1410-1440° C.;
wherein, the alloy sheet obtained after the casting has a thickness of 0.25-0.40 mm;
wherein, the process of the hydrogen decrepitation comprises hydrogen absorption, dehydrogenation, and a cooling treatment in turn;
wherein, the magnetic field strength for the magnetic field shaping is 1.8 T or more.

10. A R-T-B magnet prepared by the preparation method of the R-T-B magnet according to claim 1.

11. The R-T-B magnet according to claim 2, wherein the R-T-B magnet further comprises a Co—Ti—Nb phase; the Co—Ti—Nb phase is located in an intergranular triangular region, and a ratio of the area of the Co—Ti—Nb phase in the intergranular triangular region to the total area of the intergranular triangular region is 1.1-2.5%; and
wherein the Co—Ti—Nb phase is a Co₈Ti₁Nb₁ phase.

12. The R-T-B magnet according to claim 3, wherein the R-T-B magnet further comprises a Co—Ti—Nb phase; the Co—Ti—Nb phase is located in an intergranular triangular region, and a ratio of the area of the Co—Ti—Nb phase in the intergranular triangular region to the total area of the intergranular triangular region is 1.1-2.5%; and
wherein the Co—Ti—Nb phase is a Co₈Ti₁Nb₁ phase.

13. The R-T-B magnet according to claim 4, wherein the R-T-B magnet further comprises a Co—Ti—Nb phase; the Co—Ti—Nb phase is located in an intergranular triangular region, and a ratio of the area of the Co—Ti—Nb phase in the intergranular triangular region to the total area of the intergranular triangular region is 1.1-2.5%; and
wherein the Co—Ti—Nb phase is a Co₈Ti₁Nb₁ phase.
